(19) United States
(12) Patent Application Publication
(10) Pub. No.: US 2014/0232739 A1
(43) Pub. Date: Aug. 21, 2014

(54) APPARATUS AND METHOD FOR PROCESSING OBJECT ON SCREEN OF TERMINAL

(71) Applicant: Pantech Co., Ltd., Seoul (KR)

(72) Inventors: Myun Jung KIM, Seoul (KR); Sung Yun Kim, Seoul (KR); Won Ho Seo, Seoul (KR)

(73) Assignee: Pantech Co., Ltd., Seoul (KR)

(21) Appl. No.: 14/177,710

(22) Filed: Feb. 11, 2014

(30) Foreign Application Priority Data
Feb. 21, 2013 (KR) 10-2013-0018457

(51) Int. Cl. G09G 5/14

(52) U.S. Cl. CPC G09G 5/14
USPC 345/592; 345/635

(57) ABSTRACT

Provided is an apparatus and method for processing an object on a screen of a terminal that may receive or determine information about a recognition area of a wallpaper image of a home screen of the terminal, determine whether the recognition area and an object overlap based on information about the recognition area, and process the object so that the recognition area is not covered or concealed by the object on the home screen.

### CROSS-REFERENCE TO RELATED APPLICATION

This application claims priority from and the benefit under 35 U.S.C. §119(a) of Korean Patent Application No. 10-2013-0018457, filed on Feb. 21, 2013, which is hereby incorporated by reference for all purposes as if fully set forth herein.

### BACKGROUND

1. Field

Exemplary embodiments relate to an apparatus and method for processing an object displayed on a screen of a terminal.

2. Discussion of the Background

With the development of technologies associated with a portable terminal, the number of applications executable in the portable terminal is increasing and types of such applications are being diversified. An application installed in the portable terminal may be executed in response to a selection of a user. An application execution process is displayed on a screen of the portable terminal, and thus, the user may verify that the selected application is being executed.

A wallpaper image and an icon of an application may be displayed together on a home screen of the portable terminal. Here, the icon may be located in an area desired to be viewed by a user, such as a face of a person or a view included in the wallpaper image. Accordingly, the predetermined area may be occluded, covered, or concealed by the icon.

Currently, the user may reveal the specific area by directly changing a location of the icon in a manual manner. Accordingly, in a circumstance in which the predetermined area of the wallpaper image is occluded, covered, or concealed by the icon, there is an inconvenience to the user to manually manipulate the icon, such as by directly moving the location of the icon, in order to remove concealment of the area desired to be viewed.

### SUMMARY

The present disclosure relates to a terminal and method for arranging objects on a home screen of the terminal such that important or desired areas are not concealed by the objects.

Additional features of the invention will be set forth in the description which follows, and in part will be apparent from the description, or may be learned by practice of the invention.

According to exemplary embodiments of the present invention, a method for processing an object displayed by a terminal includes determining whether an object overlaps a recognition area of a wallpaper image of a screen of the terminal, if it is determined that the object overlaps the recognition area, processing the object to reveal the recognition area of the wallpaper, displaying the processed object and the recognition area of the wallpaper.

According to exemplary embodiments of the present invention, an apparatus to process an object on a screen of a terminal includes a determiner to determine whether a recognition area of a wallpaper of the screen of the terminal and an object overlap, a determiner to determine whether a recognition area of a wallpaper of the screen of the terminal and an object overlap, a display to display the processed object and the recognition area of the wallpaper.

It is to be understood that both forgoing general descriptions and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the principles of the invention.

FIG. 1 is a block diagram illustrating an apparatus configured to process an object on a screen of a terminal according to exemplary embodiments.

FIG. 2 illustrates an example of an object covering a face on a wallpaper image of a terminal.

FIG. 3 is a block diagram illustrating an apparatus configured to process an object on a screen of a terminal according to exemplary embodiments.

FIG. 4 illustrates an example of an object processing apparatus according to exemplary embodiments configured to recognize a face from a wallpaper image.

FIG. 5 illustrates a cell and an object displayed on a home screen of a terminal.

FIG. 6 illustrates a widget occupying a plurality of cells and coordinates of each cell on a home screen of a terminal.

FIG. 7 illustrates an operation of an object processing apparatus according to according to exemplary embodiments configured to relocate an object on a screen of a terminal.

FIG. 8 illustrates an operation of an object processing apparatus according to exemplary embodiments configured to group an object on a screen of a terminal.

FIG. 9 illustrates an operation of an object processing apparatus according to exemplary embodiments configured to perform scaling of an object on a screen of a terminal.

FIG. 10 illustrates an operation of an object processing apparatus according to exemplary embodiments configured to process an object to be transparent on a screen of a terminal.

FIG. 11 is a flowchart illustrating a method of processing an object on a screen of a terminal according to exemplary embodiments.

FIG. 12 is a flowchart illustrating a method of processing an object on a screen of a terminal according to exemplary embodiments.

FIG. 13 is a flowchart illustrating an operation of securing and moving an empty space according to exemplary embodiments.

### DETAILED DESCRIPTION OF THE ILLUSTRATED EMBODIMENTS

Exemplary embodiments of the invention will be described more fully hereinafter with reference to the accompanying drawings, in which exemplary embodiments of the invention are shown. The exemplary embodiments may, however, be embodied in many different forms and should not be construed as limited to the exemplary embodiments set forth herein. Rather, these exemplary embodiments are provided so that this disclosure is thorough and complete, and will fully convey the scope of the disclosure to those skilled in the art. In the description, details of well-known features and techniques may be omitted to avoid unnecessarily obscuring the presented embodiments. In the drawings, the size and relative sizes of layers and regions may be exaggerated for clarity. Like reference numerals in the drawings denote like elements.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first”, “second”, and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. It will be understood that for the purposes of this disclosure, “at least one of” will be interpreted to mean any combination the enumerated elements following the respective language, including combination of multiples of the enumerated elements. For example, “at least one of X, Y, and Z” will be construed to mean X only, Y only, Z only, or any combination of two or more items X, Y, and Z (e.g. XYZ, XZ, YZ, X). It will be understood that when an element is referred to as being “connected to” another element, it can be directly connected to the other element, or intervening elements may be present.

Exemplary embodiments described in the specification are wholly hardware, and may be partially software or wholly software. In the specification, “unit”, “module”, “device”, “system”, or the like represents a computer related entity, such as, hardware, combination of hardware and software, or software. For example, in the specification, the unit, the module, the device, the system, or the like may be an executed process, a processor, an object, an executable file, a thread of execution, a program, and/or a computer, but are not limited thereto. For example, both of an application which is being executed in the computer and a computer may correspond to the unit, the module, the device, the system, or the like in the specification.

In general, a mobile device may include a hardware layer, a platform to process a signal input from the hardware layer and to transfer the processed input signal, and an application program layer operated based on the platform and including various types of application programs.

A platform may be classified into Android® platform, Windows Mobile® platform, iOS® platform, and the like, based on an operating system (OS) of a mobile device. Each platform may have a different structure, but may have an identical or similar basic functionality.

The Android® platform serves to manage various types of hardware, and may include a Linux® kernel layer to transfer a request of an application program to hardware, and to transfer a response of hardware to the application program, a libraries layer including C or C++ to connect hardware and a framework layer, and the framework layer to manage various types of application programs.

In the case of the Windows Mobile® platform, a core layer corresponds to the Linux® kernel layer. The Windows Mobile® platform may include an interface layer to connect the core layer and an application program layer, and may support various types of languages and functions.

In the case of the iOS® platform, a core OS layer corresponds to the Linux® kernel layer. A Core Services Layer may be similar to the library layer and the framework layer. The iOS platform may include a Media Layer to provide a multimedia function and a Cocoa Touch Layer to serve as a layer for various types of applications.

Herein, each layer may also be expressed as a block, and the framework layer and a similar layer corresponding thereto may be defined as a software block. The following exemplary embodiments may be configured on a variety of platforms of a mobile device, but are not limited to the aforementioned platform types.

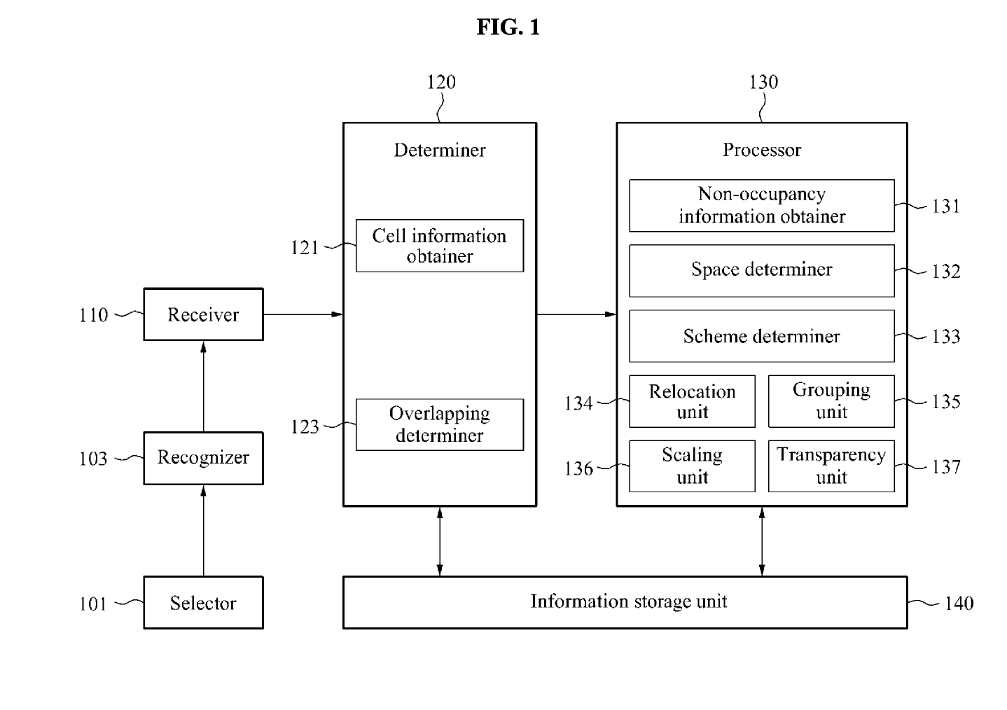

FIG. 1 is a block diagram illustrating an apparatus (hereinafter, also referred to as an object processing apparatus) configured to process an object on a screen of a terminal according to exemplary embodiments.

Referring to FIG. 1, the object processing apparatus may include a receiver 110, a determiner 120, and a processor 130.

The receiver 110 may receive information about a recognition area recognized from a wallpaper image on a home screen of a terminal. The recognition area may be an area recognized from the wallpaper image based on a criterion and may be recognized by a recognizer 103. For example, the criterion may include a face of a person, a body of the person, a smiling face, a thing or shape, and the like. The home screen of the terminal may be a screen for displaying an icon of an application, a widget, and a folder including a plurality of applications and/or widgets.

The recognizer 103 may recognize the recognition area from the wallpaper image based on a recognition algorithm. The recognizer 103 may recognize the recognition area based on at least one criterion, using a variety of recognition algorithms of an image processing field.

The recognizer 103 may recognize a facial area as the recognition area from the wallpaper image based on at least one of a geometric scheme and a photometric scheme. The geometric scheme refers to a scheme of recognizing a facial area by extracting a geometric feature points from the wallpaper image and determining whether the extracted geometric feature points and information about a pre-stored feature points match. The photometric scheme refers to a scheme of recognizing a facial area based on a feature of a shape observed under a plurality of different lighting conditions. Although described herein as a recognition area, aspects need not be limited thereto such that the area need not be recognized but may be input manually or may be determined according to other schemes or algorithms such that the area may be a determined, designated, or specific area.

A selector 101 may select an automatic scheme or a manual scheme, or a combination thereof, for image recognition from among recognition schemes of the recognition area. The selection of the automatic scheme or the manual scheme by the selector 101 may be based on an input of a user. For example, the automatic scheme and the manual scheme may be set in the selector 101. In response to a selection of the automatic scheme or the manual scheme, the recognizer 103 may perform recognition on the recognition area using the selected scheme.

In the automatic scheme, at least one of a person and a thing may be automatically recognized from the wallpaper image based on a recognition algorithm. Further, in the automatic scheme, an area satisfying a specific condition or conditions may be recognized based on the recognition algorithm. The predetermined condition may include at least one of a color, a face of a person, a person, and a thing. In the manual scheme, an area may be recognized from the wallpaper image based on a designative input of the user. Further, in the manual scheme, an area selectively input by the user may be recognized. Moreover, the automatic scheme and the manual scheme may be combined at least to some extent. For example, a user may manually indicate an area of the image in which the automatic scheme is to be performed; however aspects are not limited thereto.

The determiner 120 may determine whether the recognition area and an object overlap on the home screen based on information about the recognition area received by the receiver 110. For example, the determiner 120 may determine whether a location of the recognition area and a location of the object overlap based on information about the recognition area. Here, overlapping may be variously used depending on exemplary embodiments. As an example, overlapping may indicate a case in which the object covers or conceals the entire recognition area. Also, overlapping may indicate a case in which the object covers or conceals at least a portion of the recognition area, for example, according to a threshold area or amount of the recognition area covered or concealed by the object or a ratio of an area of the recognition area covered by the object to an area of the recognition area not covered by the object. Also, overlapping may indicate a case in which a priority is set in the recognition area and a portion of the recognition area corresponding to a top priority, or an important portion of the recognition area, is covered or concealed by the object.

For example, in a case in which a face of a person is recognized as the recognition area, a case in which the object covers or conceals the eyes and nose of the face may be defined as overlapping, and the determiner 120 may determine that the object overlaps the recognition area. For example, a case in which at least 50% of the recognition area is covered by the object may be defined as overlapping, and the determiner 120 may determine that the object overlaps the recognition area. A ratio that is a criterion to determine overlapping may be variously set, for example, from greater than 0% to 100%.

The object may be at least one of an icon of an application and a widget or other object blocking or covering an image or wallpaper image.

The determiner 120 may include a cell information obtainer 121 and an overlapping determiner 123.

The cell information obtainer 121 may obtain or determine information about a location of a cell including the recognition area based on information about the recognition area. Information about the recognition area may indicate information about cells including the recognition area among cells of the home screen.

The cell information obtainer 121 may calculate a location of each cell of the home screen and a number of cells based on coordinate information of each cell. The cell information obtainer 121 may calculate a location of each cell including the recognition area, and a number of cells including the recognition area based on coordinate information of each cell

The overlapping determiner 123 may determine whether the object is present within a cell including the recognition area based on a location of the cell obtained by the cell information obtainer 121. The overlapping determiner 123 may obtain, from an information storage unit 140, information about a cell in which the object is present. The overlapping determiner 123 may determine whether the recognition area and the object overlap in the same cell on the home screen by comparing the location of the cell in which the object is present, which is obtained from the information storage unit 140, and the location of the cell obtained by the cell information obtainer 121.

When the object is present within the cell including the recognition area, the information storage unit 140 may store information about the object as an object to be processed by the processor 130.

The information storage unit 140 may store information about a processing history of the object processed by the processor 130 and a location of the processed object. The processing history of the object may be updated before or after final processing by the processor 130.

The cell information obtainer 121 may obtain screen information of the cell including the recognition area and coordinates information of the cell including the recognition area based on information about the recognition area. The number of home screens may differ for each terminal and may be adjusted or set for each terminal. For example, when the terminal includes five home screens, and when the same wallpaper image is set for each home screen, separate screen information may not be required or determined. However, when a single wallpaper image is set for a total of five home screens, screen information corresponding to the recognition area may be required or determined.

When the determiner 120 determines that the recognition area and the location of the object overlap, the processor 130 may process the object to reveal or to not cover or conceal the recognition area on the home screen. As an example, the processor 130 may move the object to another location by moving the object from the recognition area on the home screen. As another example, when a plurality of objects overlaps the recognition area, the processor 130 may group, into a folder, an object not located in the recognition area and an object overlapping the recognition area, and may locate the folder at a location different from the recognition area. As another example, the processor 130 may downscale a size of the object. The processor 130 may process a color of the object to be transparent or semi-transparent. Whether moving, grouping, downscaling, and/or transparency changing is performed may be set according to default and/or user preference. Further, performance of the moving, grouping, downscaling, and/or transparency changing may be attempted in an order set according to default and/or preferences. For example, if the moving fails because there is not sufficient empty space to which to move the object, the grouping, the downscaling, and/or the transparency changing may be attempted to be performed. Then, for example, if the grouping is performed but fails for a reason, e.g., user denied grouping or objects dissimilar, the downscaling and/or the transparency changing may be performed.

The processor 130 may include a non-occupancy information obtainer 131, a space determiner 132, a scheme determiner 133, a relocation unit 134, a grouping unit 135, a scaling unit 136, and a transparency unit 137.

The non-occupancy information obtainer 131 may obtain or determine information regarding whether a cell unoccupied by an object is present on the home screen and information about the unoccupied cell. The non-occupancy information obtainer 131 may obtain information about cells unoccupied by an object on a plurality of home screens. The non-occupancy information obtainer 131 may calculate the number of unoccupied cells based on information about a location of each unoccupied cell. The information storage unit 140 may store location information of the object for each cell on a home screen. The non-occupancy information obtainer 131 may obtain, from the information storage unit 140, information about a cell unoccupied by the object. The non-occupancy information obtainer 131 may calculate a size of a space including unoccupied cells, based on the obtained information. The non-occupancy information obtainer 131 may verify a connection structure of unoccupied cells, and may calculate a size of an empty space connected by the plurality of unoccupied cells. The non-occupancy information obtainer 131 may also obtain information about the size of the empty space from the information storage unit 140.

The space determiner 132 may determine whether the size of the empty space is greater than or equal to a size of an object or objects overlapping the recognition area. The size of the empty space may indicate a size of the entire space of a plurality of unoccupied cells or a size of the space connected by a plurality of unoccupied cells. The space determiner 132 may determine whether the empty space has a size sufficient to include the one or more objects. For example, in a case in which five empty spaces each has a (1×1) cell size on a (4×4) home screen and the five empty spaces are separately located without being connected to each other, when an object overlapping a recognition area has a (2×1) cell size, the non-occupancy information obtainer 131 may calculate a size of an empty space as “1×1” since the five empty spaces are separately located without being connected to each other. The space determiner 132 may determine that the calculated size “1×1” of the empty space is less than the size “2×1” of the object overlapping the recognition area. The calculated size “1×1” may be indicated as being plural, for example, the space determiner 132 may determine that there are 3 “1×1” empty spaces sufficient for displaying 3 “1×1” objects.

When the size of the empty space is less than the size of the object overlapping the recognition area, the scheme determiner 133 may determine a scheme of processing the object among processing schemes including grouping, downscaling, and transparency changing based on a determined priority. For example, the scheme determiner 133 may determine whether a plurality of objects overlaps the recognition area, and may determine a processing scheme in an order of the grouping, the downscaling, and the transparency when the plurality of objects overlaps the recognition area. However, aspects of the invention are not limited thereto such that the order of the processing schemes may be different, for example, the downscaling, the grouping, and the transparency changing, or may be variously combined.

When the object is processed using the determined processing scheme, the scheme determiner 133 may receive from the determiner 120 a feedback or information on whether the processed object still overlaps the recognition area. The scheme determiner 133 may determine a processing scheme different from the processing scheme previously applied to the object based on the feedback result.

When the size of the empty space is less than the size of the object overlapping the recognition area, the scheme determiner 133 may determine a scheme of processing the object among processing schemes including the grouping, the downscaling, and the transparency changing, based on an input set by the user.

When the object includes at least one of a plurality of icons and a plurality of folders and a combination thereof, the scheme determiner 133 may determine the grouping as a first priority.

When the size of the empty space is greater than or equal to the size of the object, the scheme determiner may the processing scheme to be a moving scheme and the relocation unit 134 may relocate the object on the empty space. The size of the empty space may be a size of the entire space connected by a plurality of unoccupied cells or may include individual empty spaces.

When the grouping is determined by the scheme determiner 133, the grouping unit 135 may group, into a single folder, a plurality of icons included in the object. Here, grouping of the generated folder may be performed in order not to overlap the recognition area.

When the downscaling is determined by the scheme determiner 133, the scaling unit 136 may downscale the size of the object.

When the transparency is determined by the scheme determiner 133, the transparency unit 137 may process a color of the object to be transparent or semi-transparent.

The information storage unit 140 may store information about a processing history of the processed object and a location of the finally processed object.

The processor 130 may display a state of the object before being processed on the home screen for a period of time after a point in time when the object is processed not to cover or conceal the recognition area and a touch input event occurs on the processed object. For example, a touch input may indicate a case in which a touch input is maintained for at least a period of time. In this case, a long press event may occur. As an example, the touch input may indicate a case in which a plurality of touch inputs occurs within a period of time. In this case, a multi-touch event may occur. The processor 130 may restore the state of the object to a state of the object after being processed after the period of time is elapsed and thereby display the object on the home screen not covering or concealing the recognition area.

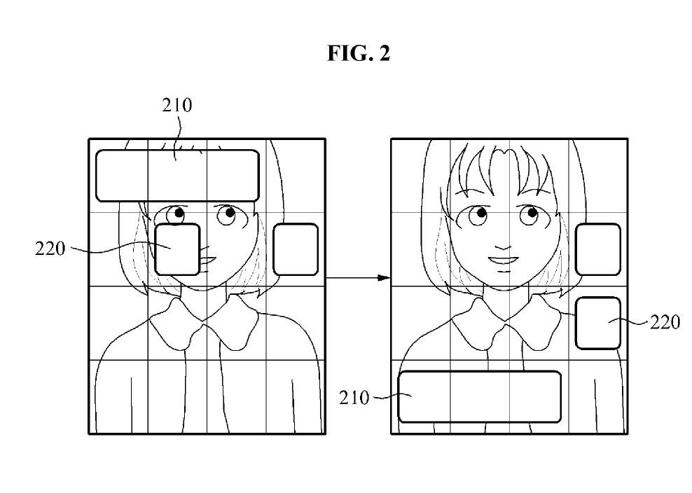

FIG. 2 illustrates an example of an object covering or concealing a face on a wallpaper image of a terminal.

Referring to the screen on the left of FIG. 2, a widget 210 and an icon 220 are located on areas in which a face of a wallpaper image is displayed. The widget 210 and the icon 220 are examples of an object and may indicate a symbol that represents an application. For example, the widget 210 is a program independently executed and indicates an application that performs a function, such as a calendar, a stock, a weather, a media player, an address directory, a memory, and the like.

Referring to the screen on the right of FIG. 2, the widget 210 and the icon 220 are located on areas different from areas in which the face of the wallpaper image is displayed. For example, an object controlling apparatus according to exemplary embodiments may determine whether the widget 210 and the icon 220 on the screen on the left are located on a facial area, or recognition area, of the wallpaper image, and, when the widget 210 and the icon 220 are determined to be located on the facial area, the object controlling apparatus may relocate the widget 210 and the icon 220 at locations as shown on the screen on the right, i.e., the widget 210 and the icon 220 are moved so that the facial area or recognition area of the wallpaper image is not covered or concealed by the widget 210 or the icon 220.

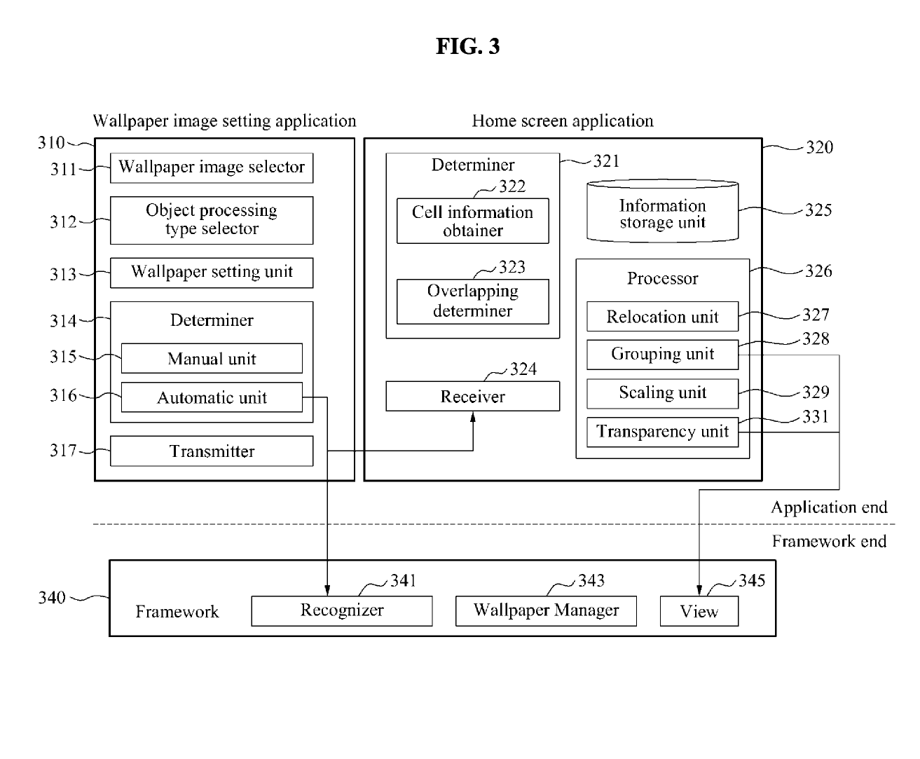

FIG. 3 is a block diagram illustrating an apparatus configured to process an object on a screen of a terminal according to exemplary embodiments.

Referring to FIG. 3 the object controlling apparatus may include a wallpaper image setting application 310 and a home screen application 320. The wallpaper image setting application 310 may include a wallpaper image selector 311, an object processing type selector 312, a wallpaper setting unit 313, a determiner 314, and a transmitter 317.

The wallpaper image setting application 310 may set information associated with a wallpaper image based on an input of a user.

The wallpaper image selector 311 may display, on the screen of the terminal, images that may be set as the wallpaper image, and may display a user interface that enables a user to select one of the images as the wallpaper image. Further, the wallpaper image selector 311 may set the wallpaper image according to a default setting or a setting of an application or the like.

When an area recognized from the wallpaper image and an object overlap, the object processing type selector 312 may display a user interface that enables the user to determine whether to process the overlapping object. When the user determines to process the overlapping object, the object processing type selector 312 may activate the home screen application 320. When the user determines not to perform separate processing of the overlapping object, the object processing type selector 312 may maintain an inactive state of the home screen application 320 or may change an active state of the home screen application 320 to the inactive state.

The wallpaper setting unit 313 may interact and/or communicate with a framework 340 so that information about the wallpaper image of the terminal may be updated based on information selected by the wallpaper image selector 311.

The determiner 314 of the wallpaper image setting application 310 may determine recognition area information of the wallpaper image in a manual manner or an automatic manner or a combination thereof. A setting scheme of the manual, the automatic, and the combination scheme may be determined based on the input of the user.

The manual scheme refers to a scheme of determining, by the user, a recognition area of the wallpaper image, and the automatic scheme refers to a scheme of enabling a recognizer 341 to automatically determine the recognition area of the wallpaper image in conjunction with the recognizer 341. The automatic scheme and the manual scheme may be combined at least to some extent, i.e., a combination scheme; for example, a user may manually indicate an area of the image in which the automatic scheme is to be performed, however aspects are not limited thereto

The determiner 314 of the wallpaper image setting application 310 may include a manual unit 315 and an automatic unit 316.

The manual unit 315 enables the user to designate the recognition area of the wallpaper image. The manual unit 315 may transfer, to the transmitter 317, information about the recognition area designated by the user.

The automatic unit 316 may transfer a control signal to the recognizer 341 so that the recognizer 341 may automatically recognize a recognition area satisfying a condition. The automatic unit 316 may transfer, to the transmitter 317, information about the recognition area recognized by the recognizer 341.

The transmitter 317 may receive information about the recognition area from the determiner 314 of the wallpaper image setting application 310 and may transfer the received information to a receiver 324 of the home screen application 320.

The home screen application 320 may include the receiver 324, a determiner 321, an information storage unit 325, and a processor 326. For example, the home screen application 320 may be an application having a launcher function in Android® operating system (OS).

The receiver 324 may receive information about the recognition area from the transmitter 317 of the wallpaper image setting application 310.

The determiner 321 of the home screen application 320 may include a cell information obtainer 322 and an overlapping determiner 323.

The cell information obtainer 322 may obtain cell information of a home screen including the recognition area based on information about the recognition area received by the receiver 324. The cell information may include a screen number in which a cell is present and coordinates of the cell on the screen.

The overlapping determiner 323 may determine whether the object is present in the corresponding cell by comparing the cell information obtained by the cell information obtainer 322 and information stored in the information storage unit 325. When the object is present within the corresponding cell, the overlapping determiner 323 may determine that the corresponding or determined cell is a principal portion or cell to be processed by the processor 326. The overlapping determiner 323 may determine that the corresponding cell is a non-principal cell when the object is absent in the corresponding cell. Further, the overlapping determiner 323 may determine that the corresponding cell is a principal or non-principal cell according to a threshold or ratio indicating the extent to which the corresponding cell overlaps recognition area; however, aspects are not limited thereto. Further, the principal portion or cell may correspond to a recognition area, and the non-principal portion or cell may correspond to an empty space.

The information storage unit 325 may store information that is classified into a principal portion or cell or a non-principal portion or cell by the overlapping determiner 323 based on information about the recognition area received from the receiver 324.

The processor 326 may process an object present within the principal portion determined by the determiner 321 of the home screen application 320. A processing scheme may include a relocating, a grouping, a downscaling, and a transparency changing. A sub-processor may be present to perform each processing scheme.

The processor 326 may include a relocation unit 327, a grouping unit 328, a scaling unit 329, and a transparency unit 331.

The relocation unit 327 may move the object present within the principal portion or cell to be relocated in the non-principal portion or cell. For example, prior to an operation of the relocation unit 327, the processor 326 may determine whether a size of the non-principal portion is greater than or equal to a size of the object present within the principal portion. The size of the non-principal portion may include a size of at least one space connected by a plurality of unoccupied cells and may include a size of individual unoccupied cells. When the size of the non-principal portion is greater than or equal to the size of the object present within the principal portion, the processor 326 may operate the relocation unit 327 to move the object present in the principal portion or cells to the non-principal portion or cells.

The grouping unit 328 may group a plurality of objects present within the principal portion into a single folder.

The scaling unit 329 may decrease the size of the object present within the principal portion. When the object is located over a plurality of cells, the scaling unit 329 may decrease the size of the object to be included in a single cell of the non-principal portion.

The transparency unit 331 enables the recognition area of the wallpaper image to be exposed on the screen by processing the object within the principal portion to be transparent or translucent, for example, silhouette processing, or at least partially or semi-transparent so that the wallpaper image may be exposed through the partially or semi-transparent object.

The framework 340 may include the recognizer 341, a wallpaper manager 343, and a view 345.

The framework 340 may display the wallpaper image and the object on the home screen based on information about the wallpaper image and the object.

The recognizer 341 may extract a recognition area satisfying a recognition condition from the wallpaper image based on the recognition condition and a control signal received from the automatic unit 316.

The wallpaper manager 343 may include a universal resource identifier (URI) and path information of an image to be used as the wallpaper image, and may display the wallpaper image selected by the wallpaper image selector 311. The wallpaper manager 343 may display the wallpaper image selected by the wallpaper image selector 311 on the home screen in interaction with the wallpaper setting unit 313.

The view 345 may display an object before-processing and an object after-processing on the home screen. For example, the view 345 may display the results of processing compared to the view of the object and the recognition area before processing is performed or completed.

As an example, the wallpaper manager 343 capable of setting a wallpaper image may be provided as an application program interface (API) in Android® OS. Functions associated with setting of the wallpaper image may be processed by WallpaperManagerService of a framework end.

When an image file is transferred, the wallpaper manager 343 enables WallpaperManagerService to generate an internal image file by calculating a resolution of the terminal screen and an area set as the home screen.

In the case of a live wallpaper image, an engine API layer is provided to play animated wallpaper image content.

In Android® OS, an area of the wallpaper image may be set as a virtual size and generally set to be twice a width of a terminal screen. Due to such settings, the wallpaper image may also move in response to a flicking gesture applied on the home screen.

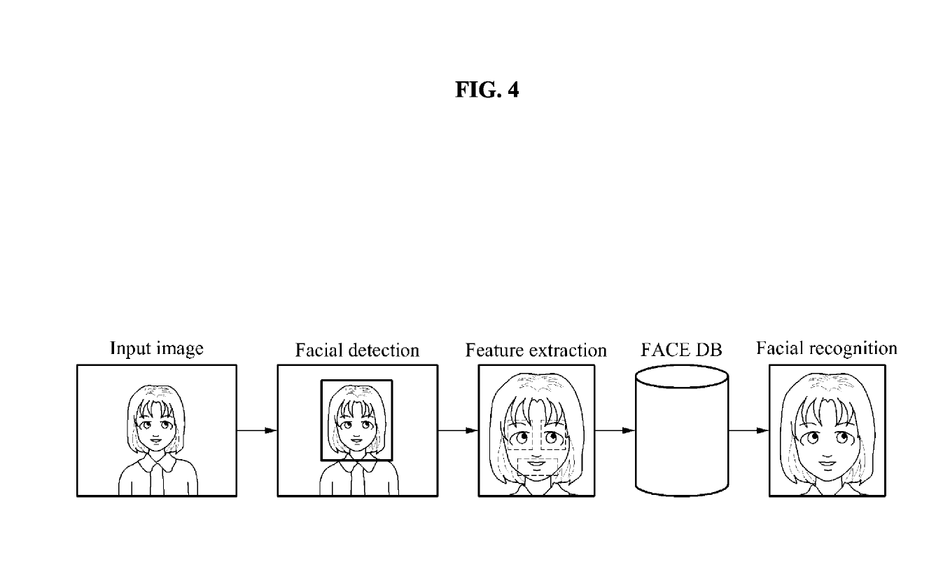

FIG. 4 illustrates an example of an object processing apparatus according to exemplary embodiments configured to recognize a face from a wallpaper image.

A facial recognition system may be a computer supporting application program configured to automatically identify each person using digital images. A basic principal of facial recognition is to compare a facial feature included in an image and a face database. Further, facial recognition may be performed manually.

Referring to FIG. 4, the object processing apparatus may perform a facial recognition function by detecting a face from an input image, extracting a feature from the face, and comparing the extracted feature and a feature stored in a face database. The face database may be included in the object processing apparatus or may be remote therefrom.

The object processing apparatus may acquire and store an image from a charge coupled device (CCD). The object processing apparatus may remove noise in the acquired image. The object processing apparatus may detect a facial area from the noise-free image. The facial area may be detected using a skin tone based method, a principal component analysis (PCA) based method, a nerve network based method, an adaptive boosting (AdaBoost) based method, and the like.

The object processing apparatus may extract a feature from the detected facial area and may normalize a brightness and a size of the detected facial area.

The object processing apparatus may recognize a facial area of a predetermined person by comparing feature information of the detected facial area and face information registered to the face database.

A scheme used for facial recognition may be classified into a geometric scheme of performing facial recognition using features, for example, a distance of and/or between eyes, noise, and lips of a face, and a photometric scheme of performing facial recognition by employing a statistical value from a facial image or image information.

Representatively, Eigenfaces, Fisherfaces, a support vector machine (SVM) based method, a neural network based method, a fuzzy and nerve network based method, and methods of performing flexible matching with a wavelet may be employed.

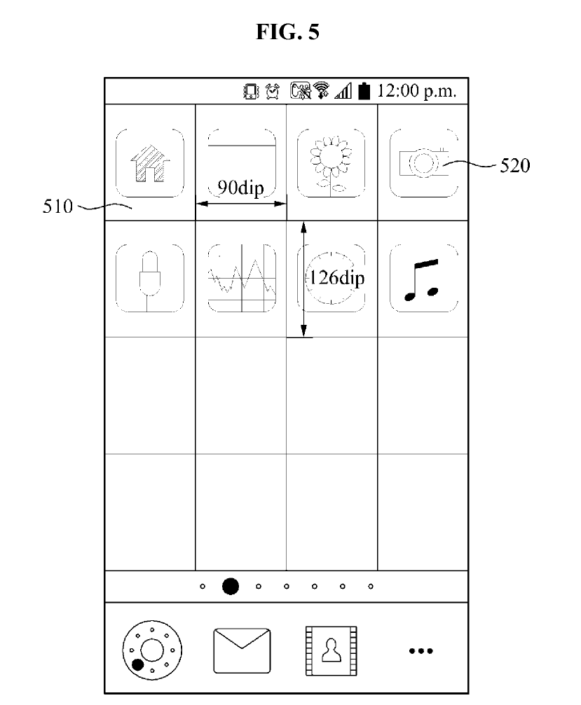

FIG. 5 illustrates a cell and an object displayed on a home screen of a terminal.

Referring to FIG. 5, the home screen of the terminal may include a plurality of cells 510. An object 520 may be located in one of the cells 510; however, aspects need not be limited thereto such that the object 520 may not be located completely in the cell 510, i.e., the object 520 may be located in one or more cells 510. In FIG. 5, the cell 510 has a width of 90 density-independent pixels (dip) and a height of 126 dip; however, aspects need not be limited thereto such that the cells 510 may have other and/or various widths and heights. For example, the size of the cell 510 may vary based on a resolution and density of the terminal.

On the home screen of the terminal, a cell grid may be used to locate an object, for example, an icon, a folder, a widget, and the like.

A cell area on the home screen may be managed using a cell grid as shown in Table 1.

TABLE 1

| | | | |
|---|---|---|---|
| (0, 0) | (0, 1) | (0, 2) | (0, 3) |
| (1, 0) | (1, 1) | (1, 2) | (1, 3) |
| (2, 0) | (2, 1) | (2, 2) | (2, 3) |
| (3, 0) | (3, 1) | (3, 2) | (3, 3) |

When a single home screen includes 4×4 grid areas, coordinates of each cell may be provided as shown in Table 1. In Table 1, a coordinate form indicates (X coordinate of a cell, Y coordinate of the cell).

A home screen application of the terminal may manage a current cell occupancy state of the home screen. An occupancy state may be expressed as a Boolean type array variable in a form of two-dimensional (2D) arrangement corresponding to a cell grid of a current screen as follows. A single occupancy state may be allocated for each screen. For example,

boolean int[ ][ ] mOccupied=new int[CELL_X_COUNT][CELL_Y_COUNT];

An arrangement value of each arrangement indicating an occupancy state may match coordinates of a cell on a home screen. When an object is present within a corresponding cell, “true” may be assigned to the cell. When the cell is empty, “false” may be assigned to the cell. The occupancy state may be updated and thereby be managed at a point in time when the object is added, moved, or deleted on the home screen.

Each object disposed on a home screen may have information about an occupying cell in a form of a tag. The tag may be an object in a form of a Java class and may include information as shown in Table 2. However, aspects need not be limited thereto.

TABLE 2

| Field | Description |
|---|---|
| cellX | CellX coordinate of an uppermost left cell at which an |
| | object is located |
| cellY | CellY coordinate of an uppermost left cell at which an |
| | object is located. |
| cellHSpan | Number of X-axis cells occupied by an object |
| cellVSpan | Number of Y-axis cells occupied by an object |
| x | X coordinate of an actual pixel of a cell (cellX, cellY) |
| y | Y coordinate of an actual pixel of a cell (cellX, cellY) |
| width | Width of an actual pixel of an object |
| height | Height of an actual pixel of an object |

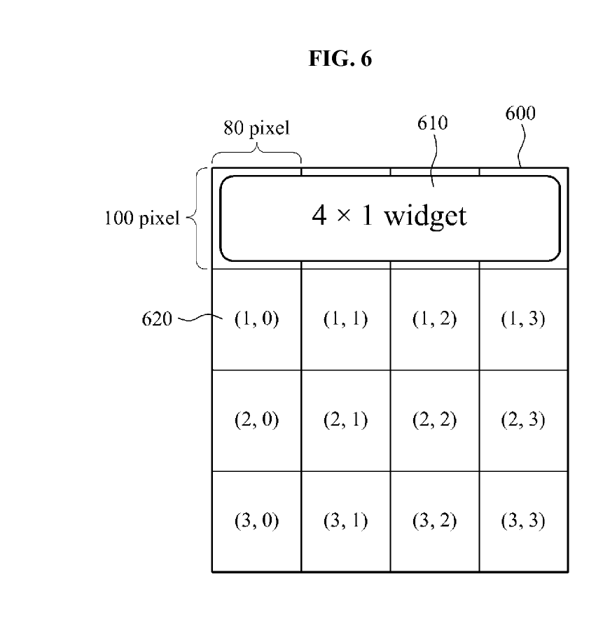

FIG. 6 illustrates a widget occupying a plurality of cells and coordinates of each cell on a home screen of a terminal.

Referring to FIG. 6, when a widget 610 having a size of (4×1) is located on a home screen 600, occupancy state information of the home screen 600 and tag information about cells included in the corresponding widget 610 may be as shown in Table 3. A cell 620 on the home screen 600 may be expressed as coordinates using a cell grid.

TABLE 3
Occupancy state

| | | | |
|---|---|---|---|
| true | true | true | true |
| false | false | false | false |
| false | false | false | false |
| false | false | false | false |

Tag information

| Field | Value |
|---|---|
| cellX | 0 |
| cellY | 0 |
| cellHSpan | 4 |
| cellVSpan | 1 |
| x | 0 |
| y | 0 |
| width | 320 |
| height | 100 |

As shown in FIG. 6, each cell is 80 pixels wide and 100 pixels high such that the width and height of the (4×1) widget are 320 pixels and 100 pixels, respectively, as shown as Tag Information in Table 3.

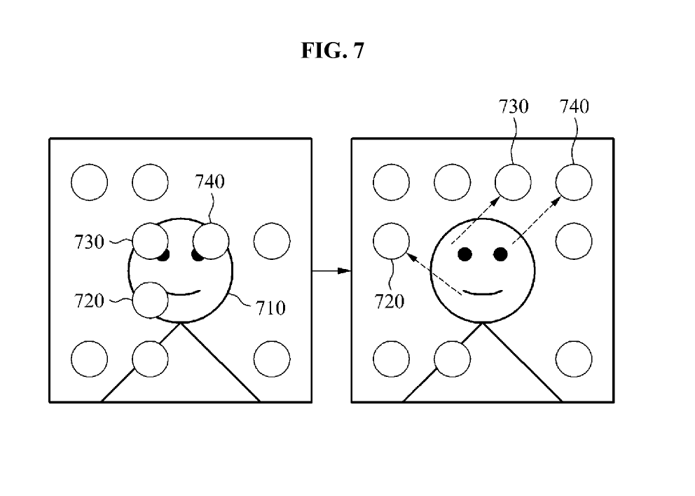

FIG. 7 illustrates an operation of an object processing apparatus according to exemplary embodiments configured to relocate an object on a screen of a terminal.

Referring to the screen on the left of FIG. 7, when a facial area 710 of a wallpaper image is recognized as a principal portion or recognition area, the object processing apparatus may relocate objects 720, 730, and 740 from the facial area 710 to one or more non-principal areas to expose or at least partially expose the facial area 710 on the home screen.

The object processing apparatus may determine that locations of the objects 720, 730, and 740 and the facial area 710 overlap, and may relocate the objects 720, 730, and 740 on an empty space as shown on the screen of the right of FIG. 7.

Although it is described in the example of FIG. 7 that the objects 720, 730, and 740 are relocated only on the empty space on the same home screen, the object processing apparatus may generate a new home screen and then relocate the objects 720, 730, and 740 on the new home screen. Also, the object processing apparatus may also relocate the objects 720, 730, and 740 on another home screen that is already generated. Also, the object processing apparatus may relocate the objects 720, 730, and 740 on different home screens, respectively.

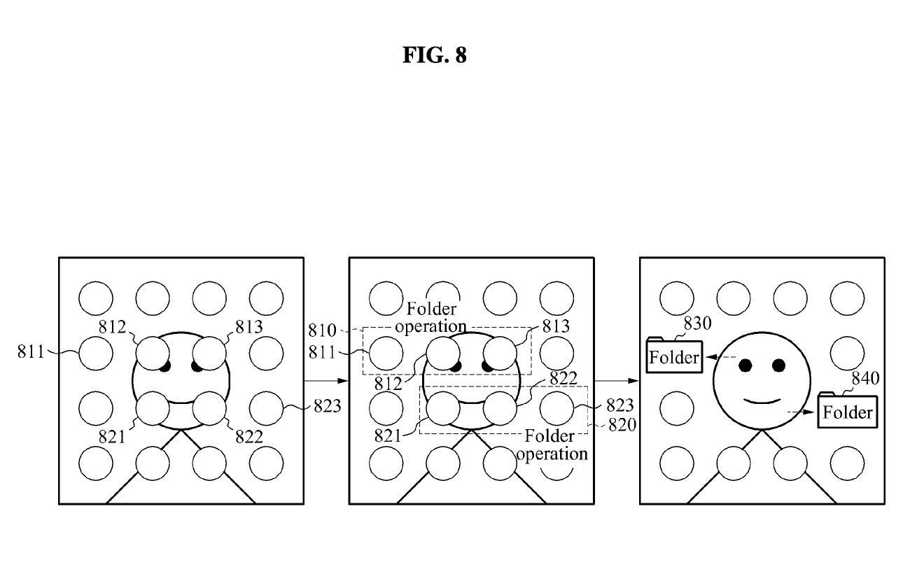

FIG. 8 illustrates an operation of an object processing apparatus according to exemplary embodiments configured to group an object on a screen of a terminal.

Referring to the screen on the left of FIG. 8, objects are present on a facial or recognition area of a wallpaper image. That is, it can be seen that objects 812, 813, 821, and 822 are located to overlap the facial area. Referring to the screen on the middle of FIG. 8, the image processing apparatus may perform folder operations 810 and 820 by grouping the objects 812, 813, 821, and 822 located on the facial area with objects 811 and 823 located outside of the facial area. Referring to the screen on the right of FIG. 8, a folder 830 generated by the folder operation 810 and a folder 840 generated by the folder operation 820 are located at different locations. That is, the folder operations 810 and 820 may be performed to locate the objects 812, 813, 821, and 822 to outside the facial or recognition area. For example, the folder 830 may be located at the location at which the object 811 was previously located, and the folder 830 may include the objects 811, 812, and 813. Further, the folder 840 may be located at the location at which the object 823 was previously located, and the folder 840 may include the objects 821, 822, and 823.

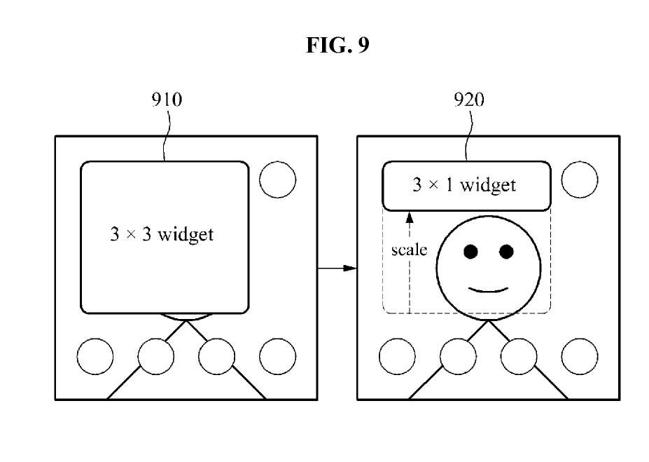

FIG. 9 illustrates an operation of an object processing apparatus according to exemplary embodiments configured to perform scaling of an object on a screen of a terminal.

Referring to the screen on the left of FIG. 9, a facial area of a wallpaper image is covered or concealed by a widget 910 having a size of (3×3). The size of the widget 910 including a plurality of cells may be processed to expose the facial area through downscaling. For example, the widget 910 may be downscaled to maintain at least one of the dimensions. As shown on the screen on the right of FIG. 9, the widget 910 may be downscaled to a widget 920 having a size of (3×1) and the facial area may be exposed on the home screen. However, aspects need not be limited thereto such that the widget 910 may be downscaled to have a size of (1×3) or to have changed dimensions (2×1), (1×1), or the like according to default or set settings and/or available empty areas and/or cells.

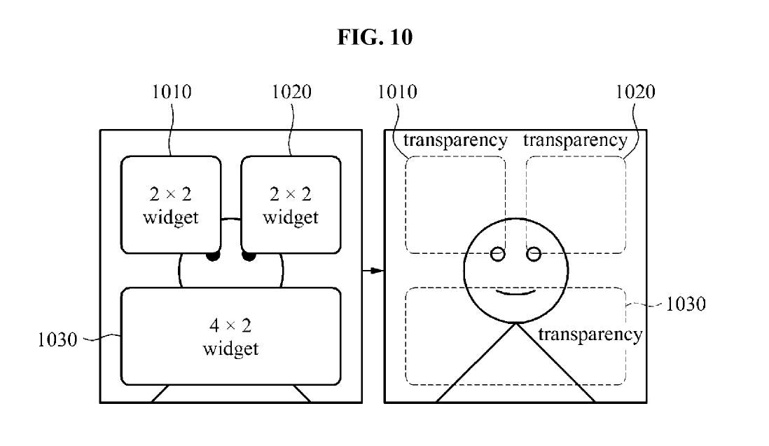

FIG. 10 illustrates an operation of an object processing apparatus according to exemplary embodiments configured to process an object to be transparent on a screen of a terminal.

Referring to the screen on the left of FIG. 10, a facial area of a wallpaper image is covered or concealed by widgets 1010 and 1020 each having a size of (2×2), and a widget 1030 having a size of (4×2). As shown on the screen on the right of FIG. 10, the facial area may be exposed on the home screen by processing colors of the widgets 1010, 1020, and 1030 to be transparent. However, aspects need not be limited thereto such that the widgets 1010, 1020, and 1030 may be partially or semi-transparent or may be displayed as outlines or combinations thereof.

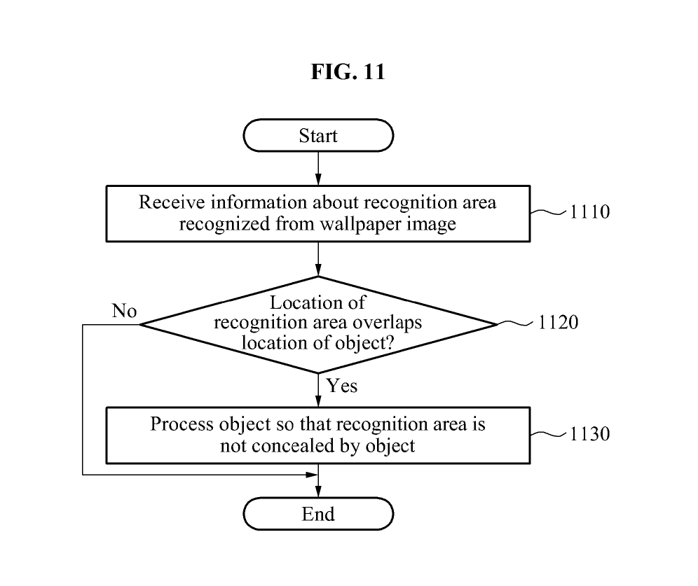

FIG. 11 is a flowchart illustrating a method of processing an object on a screen of a terminal according to exemplary embodiments.

In operation 1110, an object processing apparatus according to exemplary embodiments may receive information about a facial or recognition area recognized from a wallpaper image on a home screen of the terminal. For example, the object processing apparatus may extract the recognition area satisfying a condition based on a recognition algorithm. The recognition area may be recognized by the object processing apparatus or an apparatus different from the object processing apparatus and information about the recognition area may be received from the apparatus.

In operation 1120, the object processing apparatus may determine whether the facial or recognition area and an object indicating an application overlap based on information about the recognition area. For example, the object processing apparatus may determine whether a location of the recognition area overlaps a location of the object based on information about the recognition area. Here, a meaning of overlapping may be variously used depending on exemplary embodiments. As an example, a case in which the object covers or conceals the entire recognition area may be defined as overlapping. Also, a case in which the object covers or conceals at least a portion of the recognition area, for example, according to a ratio of the recognition area covered by the object to an area of the recognition area not covered by the object may be defined as overlapping. Also, a case in which a priority is set in the recognition area and a portion of the recognition area corresponding to a top priority, or an important portion of the recognition area, is covered or concealed by the object may be defined as overlapping.

When the location of the recognition area overlaps the location of the object, the object processing apparatus may process the object so that the recognition area may not be covered or concealed by the object on the home screen in operation 1130.

The object processing apparatus may obtain information about a location of a cell including the recognition area based on information about the recognition area, and may determine whether the object is present within the cell including the recognition area based on information about the location of the cell.

The object processing apparatus may obtain information regarding whether a cell unoccupied by an object is present on the home screen and information about the unoccupied cell.

The object processing apparatus may determine whether a size of an empty space formed based on a location of the unoccupied cell is greater than or equal to a size of the object overlapping the recognition area. Here, the size of the empty space may be a size of a space connected by a plurality of unoccupied cells. However, aspects need not be limited thereto such that the size of the empty space may include a number of (1×1) empty cells.

The object processing apparatus may relocate the objects on the empty space when the size of the empty space is greater than or equal to the size of the object. The object processing apparatus may determine a scheme of processing the object among processing schemes including a grouping, a downscaling, and a transparency changing, based on a priority when the size of the empty space is less than the size of the object.

The object processing apparatus may group, into a single folder, a plurality of icons included in the object when the grouping is determined, may downscale the size of the object when the downscaling is determined, and may process a color of the object to be transparent or semi-transparent when the transparency is determined.

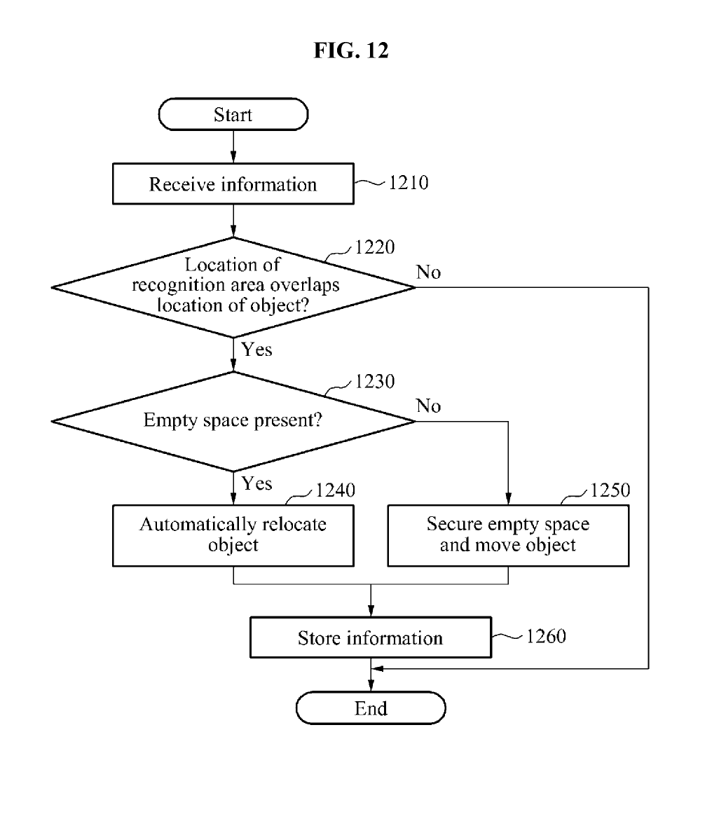

FIG. 12 is a flowchart illustrating a method of processing an object on a screen of a terminal according to exemplary embodiments.

In operation 1210, an object processing apparatus according to an exemplary embodiment may determine or receive information about a facial or recognition area recognized from a wallpaper image of a home screen of the terminal.

In operation 1220, the object processing apparatus may determine whether a location of the recognition area and a location of an object indicating an application overlap based on information about the recognition area.

When the location of the recognition area overlaps the location of the object, the object processing apparatus may determine whether one or more empty spaces are present on the home screen in operation 1230. When the object occupies at least two cells, the object processing apparatus may determine whether the empty space includes at least one empty space that is greater than or equal to the size of the object.

When the empty space is present on the home screen, the object processing apparatus may automatically relocate the object on the empty space in operation 1240. Also, when an empty space greater than or equal to the size of the object is present on the home screen, the object processing apparatus may relocate the object on the empty space. The size of the empty space may be a size of the entire space connected by a plurality of unoccupied cells or may include unconnected unoccupied cells.

When the empty space is absent on the home screen or the empty space does not include a space greater than or equal to the size of the one or more objects and/or widgets, the home processing apparatus may perform grouping or downscaling of the one or more objects and/or widgets in order to secure or generate the empty space in operation 1250. Next, the object processing apparatus may relocate the one or more objects and/or widgets on the empty space.

In operation 1260, the object processing apparatus may automatically store a location of the automatically relocated one or more objects and/or widgets and a location of the one or more objects and/or widgets moved on the secured empty space.

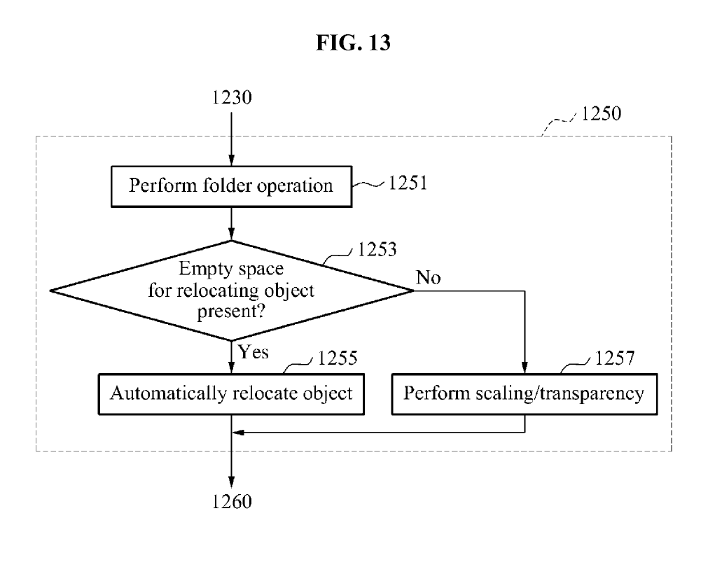

FIG. 13 is a flowchart illustrating an operation of securing and moving an empty space according to exemplary embodiments.

In operation 1251, the object processing apparatus may perform a folder operation of the one or more objects and/or widgets. For example, when the object includes a plurality of icons, widgets, and/or folders, the folder operation may be performed.

In operation 1253, the object processing apparatus may determine whether an empty space for relocating the object is present and/or available. The empty space may be a space connected by the plurality of unoccupied cells; however, aspects are not limited thereto such that the space may include unconnected unoccupied cells or multiple connected unoccupied cells. For relocating the object, the size of the empty space may be greater than or equal to the size of the object. The object processing apparatus may determine whether the size of the empty space is greater than or equal to the size of the object.

When the empty space for relocating the object is present on at least one of the home screens, the object processing apparatus may automatically relocate the object on the empty space in operation 1255.

When the empty space for relocating the object is absent on at least one of the home screens, the object processing apparatus may downscale the size of the object and/or may process a color of the object to be transparent or semi-transparent in operation 1257. FIG. 13 shows that operation 1251 is performed before the determination of whether there is sufficient empty space for relocating the object in operation 1253; however, aspects need not be limited thereto such that the folder operation 1251 may be performed after the operation 1253. Further, the scaling/transparency operation 1257 may be performed on a folder resulting from the folder operation 1251 or the objects that could be placed in the folder in the folder operation 1251 according to settings and/or preferences.

According to exemplary embodiments, there may be provided a variety of methods that may automatically determine whether an area is covered or concealed by an object, and may automatically process the object by, for example, automatically relocating the object in order not to cover or conceal the area on a screen of the terminal when the predetermined area is covered or concealed.

Also, according to exemplary embodiments, there may be provided a method that may perform relocation, grouping, downscaling, and transparency changing of an object covering or concealing an area of a wallpaper image based on a priority when the predetermined area of the wallpaper image is covered or concealed.

The exemplary embodiments according to the present invention may be recorded in non-transitory computer-readable media including program instructions to implement various operations embodied by a computer. The media may also include, alone or in combination with the program instructions, data files, data structures, and the like. The media and program instructions may be those specially designed and constructed for the purposes of the present invention, or they may be of the kind well-known and available to those having skill in the computer software arts.

It will be apparent to those skilled in the art that various modifications and variation can be made in the exemplary embodiments without departing from the spirit or scope of the invention. Thus, it is intended that the present invention cover the modifications and variations of this invention provided they come within the scope of the appended claims and their equivalents.

What is claimed is:

1. A method for processing an object displayed by a terminal, the method comprising:
determining whether an object overlaps a recognition area of a wallpaper image of a screen of the terminal;
if it is determined that the object overlaps the recognition area, processing the object to reveal the recognition area of the wallpaper; and
displaying the processed object and the recognition area of the wallpaper.

2. The method of claim 1, wherein the object is determined to overlap the recognition area when the object completely overlaps the entire recognition area or according to an amount of area of the recognition area overlapped by the object.

3. The method of claim 1, wherein the object is determined to overlap the recognition area when a priority portion of the recognition area is overlapped by the object.

4. The method of claim 1, wherein the processing the object comprises:
moving the object to an empty space of the wallpaper image outside of the recognition area.

5. The method of claim 1, wherein the processing the object comprises:
grouping the object outside of the recognition area in a folder, and displaying the folder outside of the recognition area.

6. The method of claim 1, wherein the object is a widget having at least one dimension being greater than 1, and
wherein the processing the object comprises downscaling the at least one dimension of the widget.

7. The method of claim 1, wherein the processing the object comprises changing a transparency of the object.

8. The method of claim 1, wherein, if no empty space large enough to accept the object exists, the processing comprises processing the object according to at least one of a grouping, a downscaling, and a transparency changing.

9. The method of claim 1, further comprising:
determining whether the object is present within a cell of the screen of the terminal; and
comparing a location of the recognition area and a location of the cell,
wherein the determining whether the object overlaps the recognition area of the wallpaper image is according to the comparing.

10. The method of claim 1, further comprising storing a processing history of the processed object and a location of the processed object.

11. The method of claim 1, further comprising:
determining an empty space of the screen, the empty space being unoccupied by objects; and
when a size of the empty space is greater than or equal to a size of the object, the processing comprises moving the object to the empty space.

12. The method of claim 1, further comprising:
determining an empty space of the screen, the empty space being unoccupied by objects; and
when a size of the empty space is less than a size of the object, the processing comprises securing an empty space and moving the object to the secured empty space.

13. An apparatus to process an object on a screen of a terminal, the apparatus comprising:
a determiner to determine whether a recognition area of a wallpaper of the screen of the terminal and an object overlap;
a processor to process the object to reveal the recognition area of the wallpaper if the determiner determines that the recognition area and the object overlap; and
a display to display the processed object and the recognition area of the wallpaper.

14. The apparatus of claim 13, further comprising:
a recognizer to determine the recognizer according to a determined recognition scheme and to generate information about the recognition area,
wherein the determiner determines whether the recognition area and the object overlap based on the information about the recognition area.

15. The apparatus of claim 13, wherein the determiner comprises:
a cell information obtainer to obtain information about a location of a cell including the recognition area based on the information about the recognition area; and
an overlapping determiner to determine whether the object is present within a cell including the recognition area based on the location of the cell obtained by the cell information obtainer.

16. The apparatus of claim 15, further comprising an information storage unit to store information about a cell in which the object is present,
wherein the overlapping determiner receives the information about the cell in which the object is present from the information storage unit and determines whether the object is present within a cell including the recognition area based on the information about the cell in which the object is present.

17. The apparatus of claim 13, wherein the processor comprises:
a non-occupancy information obtainer to obtain information about cells unoccupied by an object on the screen;
a space determiner to determine whether empty space of the screen is greater than or equal to a size of the object, the empty space being based on the information about cells unoccupied by an object on the screen; and
a scheme determiner to determine a processing scheme according to the determination of the space determiner,
wherein the processor processes the object according to the processing scheme.

18. The apparatus of claim 17, wherein, if the space determiner determines that the empty space is greater than or equal to the size of the object, the scheme determiner determines the processing scheme as a moving scheme, and a relocation unit of the processor moves the object to the empty space.

19. The apparatus of claim 17, wherein, if the space determiner determines that the empty space is less than the size of the object, the scheme determiner determines the processing scheme as a grouping, a downscaling, or a transparency changing scheme.

20. The apparatus of claim 19, wherein the scheme determiner determines the processing scheme in an order of the grouping, the downscaling, and the transparency schemes.
